(19) United States
(12) Patent Application Publication
(10) Pub. No.: US 2022/0318634 A1
(43) Pub. Date: Oct. 6, 2022

(54) METHOD AND APPARATUS FOR RETRAINING COMPRESSED MODEL USING VARIANCE EQUALIZATION

(71) Applicant: NOTA, INC., Daejeon (KR)

(72) Inventor: Myungsu CHAE, Daejeon (KR)

(73) Assignee: NOTA, INC., Daejeon (KR)

(21) Appl. No.: 17/842,611

(22) Filed: Jun. 16, 2022

Related U.S. Application Data
(63) Continuation of application No. PCT/KR2020/001075, filed on Jan. 22, 2020.

(30) Foreign Application Priority Data
Dec. 19, 2019 (KR) 10-2019-0170492
Jan. 22, 2020 (KR) 10-2020-0008276

(51) Int. Cl. G06N 3/08

(52) U.S. Cl. CPC G06N 3/082

(57) ABSTRACT

Disclosed are a method and apparatus for retraining a compression model using variance equalization. The method of retraining a compression model includes training a deep learning model, pruning a weight of the trained deep learning model, and retraining, using the pruned weight, the deep learning model whose weight has been pruned. A variance of the pruned weight is reduced through variance equalization.

### CROSS-REFERENCES TO RELATED APPLICATIONS

This is a continuation of International Application No. PCT/KR2020/001075, filed Jan. 22, 2020, which claims the benefits of Korean Patent Application No. 10-2019-0170492, filed on Dec. 19, 2019, and Korean Patent Application 10-2020-0008276, filed on Jan. 22, 2020, the disclosures of which are incorporated herein by reference in their entirety.

### TECHNICAL FIELD

The following description relates to a technology for retraining a compression model using variance equalization.

### BACKGROUND OF THE DISCLOSURE

A neural network is widely used in the artificial intelligence field, such as image recognition and an autonomous vehicle.

The neural network includes an input layer, an output layer, and one or two or more internal layers between them.

The output layer includes one or two or more neurons. Each of the input layer and the internal layer includes multiple neurons.

Neurons included in an adjacent layer are variously connected through synapses. A weight is assigned to each synapse.

Values of neurons included in the input layer are determined based on an input signal such as an image, that is, a recognition target, for example.

Values of neurons included in the internal layer and the output layer are computed based on neurons included in a previous layer and a corresponding synapse.

In the neural network connected as described above, the weight of the synapse is determined through a training operation.

In the neural network, various methods of initializing a layer weight are researched.

Korean Patent Application Publication No. 10-2018-0084969 (Jul. 25, 2018) discloses a technology for forming an initialization neural network model by initializing each weight in a neural network model based on each weight in a neural network sub-model.

An object of the weight initialization is to prevent a layer activation output from exploding or vanishing in a forward passage process through a deep neural network.

If the layer activation output explodes or vanishes, there occurs a problem with network convergence because a loss gradient is too great or small.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments provide a method and apparatus capable of retraining a compression model by using variance equalization.

Embodiments provide a method and apparatus capable of having optimal model performance upon retraining through a pruning scheme.

In various embodiments, in a method of retraining a compression model executed in a computer device, the computer device includes at least one processor configured to execute computer-readable instructions included in a memory. The method includes training, by the at least one processor, a deep learning model, pruning, by the at least one processor, a weight of the trained deep learning model, retraining, by the at least one processor, the deep learning model whose weight has been pruned using the pruned weight. A variance of the pruned weight is reduced through variance equalization.

Furthermore, a computer device includes at least one processor implemented to execute computer-readable instructions included in a memory. The at least one processor is configured to process processes of training a deep learning model, pruning a weight of the trained deep learning model, and retraining, using the pruned weight, the deep learning model whose weight has been pruned. A variance of the pruned weight is reduced through variance equalization.

The retraining of deep learning model may be performed by using an iterative pruning scheme. The iterative pruning scheme may include pruning some weights of the trained deep learning model by deleting the weights, then retraining the pruned deep learning model, and pruning some weights of the retrained deep learning model by deleting the weights.

The weight of the trained deep learning model may be pruned through the pruning of the trained deep learning model.

The variance of the pruned weight may be increased by the pruning, and the increased variance by the pruning may be reduced through variance equalization.

According to embodiments of the present disclosure, a compression model can be effectively retrained by using variance equalization.

According to embodiments of the present disclosure, optimal model performance can be achieved by reducing a variance of a pruned weight upon retraining through a pruning scheme.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a block diagram for describing an example of internal components of a computer device in an embodiment of the present disclosure.

FIG. 2 is a flowchart illustrating an example of a common iterative pruning scheme.

FIG. 3 is a flowchart illustrating an example of a pruning scheme, that is, a method of obtaining a sub-network having high accuracy, although training is performed by using a small number of weights compared to the existing method.

FIG. 4 is a flowchart illustrating an example of a method of retraining a compression model, which may be performed by the computer device, according to an embodiment of the present disclosure.

### DETAILED DESCRIPTION

While illustrative embodiments have been illustrated and described, it will be appreciated that various changes can be made therein without departing from the spirit and scope of the disclosure.

Hereinafter, embodiments of the present disclosure are described in detail with reference to the accompanying drawings.

Embodiments of the present disclosure relate to a technology for retraining a compression model.

Embodiments including contents specifically described in this specification can effectively retrain a compression model by using variance equalization. Accordingly, greater advantages can be achieved in terms of network convergence, model performance, etc.

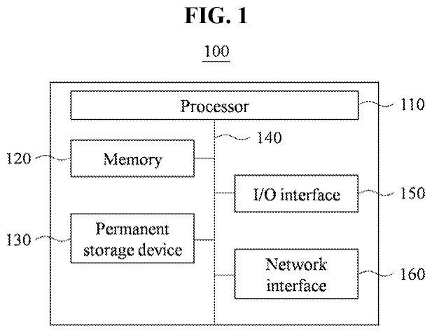

FIG. 1 is a block diagram for describing an example of internal components of a computer device in an embodiment of the present disclosure. For example, a deep learning system according to embodiments of the present disclosure may be implemented through a computer device 100 of FIG. 1. As illustrated in FIG. 1, the computer device 100 is a component for executing a method of retraining a compression model, and may include a processor 110, a memory 120, a permanent storage device 130, a bus 140, an input/output (I/O) interface 150, and a network interface 160.

The processor 110 is a component for retraining a compression model, and may include an arbitrary device capable of processing a sequence of instructions or may be a part of the arbitrary device. The processor 110 may include a computer processor, a mobile device or a processor and/or a digital processor within another electronic device, for example. The processor 110 may be included in a server computing device, a server computer, a series of server computers, a server farm, a cloud computer, or a content platform, for example. The processor 110 may be connected to the memory 120 through the bus 140.

The memory 120 may include a volatile memory, a permanent memory, a virtual memory or other memories for storing information which is used or outputted b y the computer device 100. The memory 120 may include a random access memory (RAM) and/or a dynamic RAM (DRAM), for example. The memory 120 may be used to store arbitrary information, such as state information of the computer device 100. The memory 120 may also be used to store instructions of the computer device 100 including instructions for retraining a compression model, for example. The computer device 100 may include one or more processors 110, if necessary or if appropriate.

The bus 140 may have a communication-based structure which enables an interaction between various components of the computer device 100. The bus 140 may carry data between components of the computer device 100, for example, between the processor 110 and the memory 120. The bus 140 may include a wireless and/or wired communication medium between components of the computer device 100, and may include parallel, serial or other topology arrays.

The permanent storage device 130 may include components a memory or another permanent storage device, such as that used by the computer device 100 in order to store data for given extended period (e.g., compared to the memory 120). The permanent storage device 130 may include a non-volatile main memory, such as that used by the processor 110 within the computer device 100. The permanent storage device 130 may include a flash memory, a hard disc, an optical disc, or other computer-readable media, for example.

The I/O interface 150 may include interfaces for a keyboard, a mouth, a voice command input, a display, or other input or output devices. An input for configuration instructions and/or retraining a compression model may be received through the I/O interface 150.

The network interface 160 may include one or more interfaces for networks, such as a short-distance network or the Internet. The network interface 160 may include interfaces for wired or wireless connections. An input for configuration instructions and/or retraining a compression model may be received through the network interface 160.

Furthermore, in other embodiments, the computer device 100 may include more components than the components of FIG. 1. However, most of conventional components do not need to be clearly illustrated. For example, the computer device 100 may be implemented to include at least some of I/O devices connected to the I/O interface 150 or may further include other components, such as a transceiver, a global positioning system (GPS) module, a camera, various sensors, and a database.

Deep Learning Model Initialization

In order for a deep learning model to perform a specific task, a value of a weight (or a parameter) that defines the deep learning model is determined through a process called training.

In this case, a process called weight initialization is performed before the process called the training of the deep learning model is performed. A process of initializing a weight of the deep learning model to a specific value and changing a value of the weight based on a dataset and a loss function through a gradient decent method is called the training of the deep learning model.

Various methods are researched in relation to the weight initialization method. A basic object of the weight initialization is to solve a problem in that a layer activation output explodes (i.e., gradient exploding) or vanishes when a deep learning model is deeply accumulated.

Transfer Learning

Transfer learning means a method of training a deep learning model in another task and then retraining the trained model in another task.

In general, a deep learning model is trained in a massive dataset, such as ImageNet classification, and is then trained in a smaller dataset. In such a case, better performance is achieved compared to a method of initializing the deep learning model and then training the deep learning model.

Network Pruning

Network pruning is a scheme for reducing the size of a deep learning model while deleting a weight of the deep learning model, which is determined to have low importance.

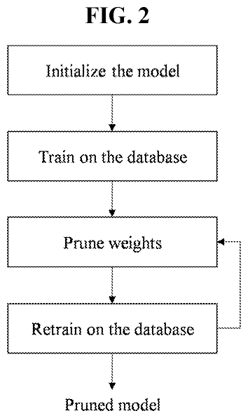

Referring to FIG. 2, a deep learning model is initialized and trained by using a dataset of a database. Thereafter, weight pruning is performed on the deep learning model. In this case, an iterative pruning scheme, that is, a method of pruning a weight of the deep learning model determined to have low importance by deleting the weight, retraining the deep learning model, and pruning a weight of the retrained deep learning model by deleting the weight, is commonly used.

When the retraining is performed, a weight left in the state in which only some weights are removed from the trained deep learning model has a value of the weight of the trained deep learning model.

Lottery Ticket Hypothesis

“Lottery Ticket Hypothesis” is used as one of new pruning schemes different from the iterative pruning scheme.

A lottery ticket hypothesis model is a pruning scheme, that is, a method of obtaining a sub-network having high accuracy although a deep learning model is trained by using a small number of weights compared to the existing method.

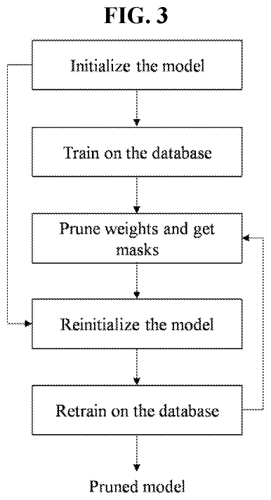

The iterative pruning scheme uses some of a trained model upon retraining. In contrast, referring to FIG. 3, in the lottery ticket hypothesis scheme, the retraining of a deep learning model is started based on an initial value of a weight of the deep learning model before weights are pruned by using only architecture of a pruning model. That is, if a specific weight w within a deep learning model is initialized as wo and the deep learning model has been trained by using w*, the retraining of the deep learning model is started based on the weight w* in the iterative pruning scheme, whereas the retraining of the deep learning model is started based on the weight wo in the lottery ticket hypothesis scheme.

The lottery ticket hypothesis scheme can obtain better performance than the iterative pruning scheme, but has limitations in that already trained w* is not used.

The present embodiment proposes a method of retraining a compression model in which how an initial value when network training is started is considered in terms of performance, not simply solving the gradient exploding and vanishing problems based on how an initial value when network training is started is set.

In other words, there is proposed a method of retraining a compression model, which can have optimal performance upon retraining in the pruning scheme proposed in the iterative pruning scheme (FIG. 2) and the lottery ticket hypothesis scheme (FIG. 3).

A method for an initialization method having optimal performance in a situation in which various schemes are developed in various types of pruning, initialization, and transfer learning is not sufficiently researched.

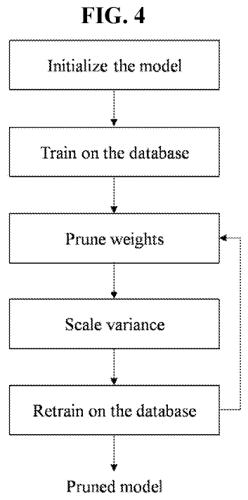

FIG. 4 is a flowchart illustrating an example of a method of retraining a compression model, which may be performed by the computer device, according to an embodiment of the present disclosure.

In the method of retraining a compression model in FIG. 4, steps may not occur in an illustrated sequence, and some of the steps may be omitted or an addition process may be included in the method.

The processor 110 may load, onto the memory 120, a program code stored in a program file for a method of retraining a compression model. For example, the program file for the method of retraining a compression model may be stored in the permanent storage device 130 described with reference to FIG. 1. The processor 110 may control the computer device 100 so that the program code is loaded from the program file stored in the permanent storage device 130 to the memory 120 through the bus. In this case, in order to execute the method of retraining a compression model, the processor 110 and components of the processor 110 may directly process an operation according to a control command or may control the computer device 100 to process an operation according a control command.

Referring to FIG. 4, the processor 110 initializes a deep learning model by initializing a value of a weight that defines the deep learning model (initialize the model).

The processor 110 trains the deep learning model by training the weight of the initialized deep learning model by using a dataset of a database (train on the database) The processor 110 performs weight pruning for deleting a weight having low importance among weights of the trained deep learning model (prune weights). In this case, the weight pruning may be performed by pruning the weight of the deep learning model through the pruning of the deep learning model.

The processor 110 reduces a variance of the pruned weight of the deep learning model on which the weight pruning has been performed (scale variance).

The processor 110 retrains the deep learning model whose weights have been pruned by using a dataset of the database after reducing the variance of the pruned weights of the deep learning model (retrain on the database).

In this case, the processor 110 uses the iterative pruning scheme, that is, a method of retraining the deep learning model after reducing the variance of the pruned weights of the deep learning model and then deleting a weight of the retrained deep learning model again, but may reduce a variance of the pruned weights in each process. In other words, as illustrated in FIG. 4, the weight pruning, the reducing of weight variance, and the retraining of the deep learning model may be repeated.

The most important thing in the initialization of the deep learning model is a variance of weight. When a variance of weight is too great or small, the gradient exploding or vanishing problem occurs.

A pruned weight may basically have a great variance due to pruning. In the present embodiment, an already trained weight w* is used after the initialization of a deep learning model, but a variance of pruned weight is adjusted to become small. Such adjustment may be performed by using variance equalization.

As described above, according to embodiments of the present disclosure, a compression model can be effectively retrained by using variance equalization. In particular, optimal model performance can be achieved by reducing a variance of weight upon retraining through a pruning scheme.

The aforementioned device may be implemented as a hardware component, a software component, or a combination of a hardware component and a software component. For example, the device and component described in the embodiments may be implemented using a processor, a controller, an arithmetic logic unit (ALU), a digital signal processor, a microcomputer, a field programmable gate array (FPGA), a programmable logic unit (PLU), a microprocessor, or one or more general-purpose computers or special-purpose computers, such as any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may understand that the processing device may include a plurality of processing elements and/or a plurality of types of processing elements. For example, the processing device may include a plurality of processors or a single processor and a single controller. Furthermore, a different processing configuration, such as a parallel processor, is also possible.

Software may include a computer program, a code, an instruction or a combination of one or more of them and may configure a processing device so that the processing device operates as desired or may instruct the processing devices independently or collectively. The software and/or the data may be embodied in any type of machine, a component, a physical device, a computer storage medium or a device in order to be interpreted by the processing device or to provide an instruction or data to the processing device. The software may be distributed to computer systems connected over a network and may be stored or executed in a distributed manner. The software and the data may be stored in one or more computer-readable recording media.

The method according to an embodiment may be implemented in the form of a program instruction executable by various computer means and stored in a computer-readable medium. In this case, the medium may continue to store a program executable by a computer or may temporarily store the program for execution or download. Furthermore, the medium may be various recording means or storage means having a form in which one or a plurality of pieces of hardware has been combined. The medium is not limited to a medium directly connected to a computer system, but may be one distributed over a network. An example of the medium may be one configured to store program instructions, including magnetic media such as a hard disk, a floppy disk and a magnetic tape, optical media such as a CD-ROM and a DVD, magneto-optical media such as a floptical disk, a ROM, a RAM, and a flash memory. Furthermore, other examples of the medium may include an app store in which apps are distributed, a site in which other various pieces of software are supplied or distributed, and recording media and/or storage media managed in a server.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and the equivalents of the claims fall within the scope of the claims.

1. A method of retraining a compression model executed in a computer device,
wherein the computer device comprises at least one processor configured to execute computer-readable instructions included in a memory, and
wherein the method comprises:
training, by the at least one processor, a deep learning model;
pruning, by the at least one processor, a weight of the trained deep learning model;
retraining, by the at least one processor, the deep learning model whose weight has been pruned using the pruned weight, and
wherein a variance of the pruned weight is reduced through variance equalization.

2. The method of claim 1, wherein the retraining of deep learning model is performed by using an iterative pruning scheme,
wherein the iterative pruning scheme includes pruning some weights of the trained deep learning model by deleting the weights, then retraining the pruned deep learning model, and pruning some weights of the retrained deep learning model by deleting the weights.

3. The method of claim 1, wherein the weight of the trained deep learning model is pruned through the pruning of the trained deep learning model.

4. The method of claim 1, wherein:
the variance of the pruned weight is increased by the pruning, and
the increased variance by the pruning is reduced through variance equalization.

5. A computer device comprising:
at least one processor implemented to execute computer-readable instructions included in a memory,
wherein the at least one processor is configured to process processes of:
training a deep learning model;
pruning a weight of the trained deep learning model; and
retraining, using the pruned weight, the deep learning model whose weight has been pruned,
wherein a variance of the pruned weight is reduced through variance equalization.

6. The computer device of claim 5, wherein the at least one processor processes the processes by using an iterative pruning scheme,
wherein the iterative pruning scheme includes pruning some weights of the trained deep learning model by deleting the weights, then retraining the pruned deep learning model, and pruning some weights of the retrained deep learning model by deleting the weights.

7. The computer device of claim 5, wherein:
the variance of the pruned weights is increased by the pruning, and
the increased variance by the pruning is reduced through variance equalization.
